(19) United States
(12) Patent Application Publication
(10) Pub. No.: US 2025/0323450 A1
(43) Pub. Date: Oct. 16, 2025

(54) CONNECTOR UNIT

(71) Applicant: HOSIDEN CORPORATION, OSAKA (JP)

(72) Inventor: Keisuke KAMIYA, Osaka (JP)

(21) Appl. No.: 19/071,104

(22) Filed: Mar. 5, 2025

(30) Foreign Application Priority Data
Apr. 16, 2024 (JP) 2024-066121

(51) Int. Cl. H01R 13/52; H01R 13/506; H01R 13/66

(52) U.S. Cl. CPC H01R 13/5213; H01R 13/506; H01R 13/6658

(57) ABSTRACT

A connector unit includes: a housing including an end wall with an insertion hole configured to receive a plug to be inserted in a connector; a lid configured to block the insertion hole; and a hinge coupling the lid to the housing, the hinge including: a hinge block disposed on an outer wall face of the end wall and having a first axial hole; a bearing disposed on the lid and having a second axial hole; and a hinge shaft extending through the first axial hole and the second axial hole, the lid being rotatable about the hinge shaft relative to the housing to be switched from a closed orientation to an open orientation, the lid including a contact section configured to, during the rotation, come into contact with a contact surface of the hinge block to define a limit of the rotation on an opening side.

### CROSS REFERENCE TO RELATED APPLICATION

This application is based on and claims priority under 35 U.S.C. Section 119 to Japanese Patent Application No. 2024-066121 filed on Apr. 16, 2024, the entire content of which are incorporated herein by reference.

### Technical Field

This disclosure relates to a connector unit.

### Related Art

JP 2018-195455 A discloses an on-vehicle connector including: a body housing with an end provided with a front panel having a plug insertion opening; and upper and lower shutter plates configured to block and expose the plug insertion opening.

The connector is configured such that the upper and lower shutter plates block the plug insertion opening while a plug is not inserted in the plug insertion opening and are movable to expose the plug insertion opening and allow a plug to be inserted therein.

### SUMMARY

The connector disclosed in JP 2018-195455 A is configured such that applying pressure to insert a plug moves a pair of shutter plates near the plug insertion opening to expose the plug insertion opening. This configuration may, however, let dust or water droplets enter the connector through the plug insertion opening.

If, in particular, the shutter plates face upward, dust or water droplets may adhere to the outer wall face of each shutter plate with the shutter plates closed. Inserting a plug may then let the dust or water droplets enter the connector. The connector leaves room for improvement in this regard.

The above circumstances have led to a demand for a connector unit configured to appropriately prevent dust or water droplets from entering a connector.

A connector unit as an embodiment of this disclosure includes: a connector; a substrate on which the connector is mounted; a housing containing the substrate and including an end wall with an insertion hole configured to receive a plug to be inserted in the connector; a lid attached to the housing and switchable between a closed orientation, in which the lid blocks the insertion hole, and an open orientation, in which the lid exposes the insertion hole; and a hinge connected to the housing and the lid and coupling the lid to the housing in such a manner that the lid is switchable between the closed orientation and the open orientation, the hinge including: a hinge block disposed on an outer wall face of the end wall, having a first axial hole parallel to the outer wall face, and having a contact surface facing the outer wall face; at least one bearing disposed on the lid and having a second axial hole; and a hinge shaft extending through the first axial hole and the second axial hole and coupling the lid to the housing, the lid being rotatable about the hinge shaft relative to the housing to be switched from the closed orientation to the open orientation, the lid including a contact section configured to, during the rotation, come into contact with the contact surface to define a limit of the rotation on an opening side.

With the above configuration, the hinge allows the lid to rotate relative to the housing into the closed orientation to block the insertion hole in the end wall of the housing. Rotating the lid into the open orientation causes the contact section to come into contact with a contact surface facing the outer wall face of the hinge block to define a limit of the rotation of the lid on the opening side. This exposes the insertion hole to allow a plug to be easily inserted into and pulled out of the connector. The hinge block may have a first axial hole near the end wall for the connector unit to be downsized. Simply designing the lid to have a contact section makes it possible to define a limit of the rotation of the lid on the opening side, and prevents the lid and/or the housing from being damaged as a result of the lid being rotated more than intended. The connector unit is therefore configured to appropriately prevent dust or water droplets from entering a connector.

The connector unit may be further configured such that the lid has a hinge depression in which the hinge block is fitted in such a manner that the hinge block is in contact with an edge of the hinge depression, the second axial hole is coaxial with the first axial hole with the hinge block fitted in the hinge depression, and the contact section is at the hinge depression.

With the above configuration, fitting the hinge block on the end wall into the hinge depression in the lid allows the lid to protrude from the end wall by a reduced amount, thereby allowing the connector unit to be downsized.

The connector unit may be further configured such that the hinge depression has a dimension along a longitudinal direction of the hinge shaft, and the contact section has a dimension along the longitudinal direction of the hinge shaft which dimension is equal to or slightly smaller than the dimension of the hinge depression.

The above configuration allows the contact section to have a maximum dimension along the longitudinal direction of the hinge shaft, and thereby ensures the contact between the contact section and the hinge block. This in turn prevents the contact section and the hinge block from being easily deformed or worn out as a result of the contact section being repeatedly brought into contact with the hinge block, and allows the lid to have an orientation as the opening limit over an extended period of time.

The connector unit may be further configured such that the at least one bearing includes two bearings with the hinge block in-between along a length of the hinge shaft.

The above configuration allows the lid to be held at two positions with the hinge block in-between. This in turn allows the lid to rotate stably and improves the durability of the hinge.

The connector unit may be further configured such that the hinge block has a block end face having a central area in which the first axial hole is present, the at least one bearing has a lid end face facing the block end face and having a central area in which the second axial hole is present, the hinge block includes a protruding engagement section protruding from the central area of the block end face, and the at least one bearing includes in the central area of the lid end face a groove in which the protruding engagement section is fitted.

The above configuration allows the lid to become attached to the housing through an operation of fitting the protruding engagement section on the block end face into the groove in the lid end face and moving the protruding engagement section along the groove until the first axial hole is coaxial with the second axial hole to allow a hinge shaft to be inserted easily.

The connector unit may be further configured such that the lid is rotatable about an open and close axis to be opened and closed, and with the lid in the closed orientation, the groove extends radially from the open and close axis toward the end wall.

With the above configuration, orienting the lid similarly to the closed orientation and moving the entire lid toward the end wall allows the first axial hole to be coaxial with the second axial hole, facilitating the attachment of the lid to the housing.

### BRIEF DESCRIPTION OF DRAWINGS

FIG. 1 is a perspective view of a connector unit with a lid in a closed orientation.

FIG. 2 is a perspective view of a connector unit with a lid in an open orientation.

FIG. 3 is an exploded perspective view of a connector unit from above.

FIG. 4 is an exploded perspective view of a connector unit from below.

FIG. 5 is a perspective view of a lid and a hinge block.

FIG. 6 is a cross-sectional view of an upper portion of a connector unit with a lid in an open orientation.

FIG. 7 is a cross-sectional view of an upper portion of a connector unit with a lid in a closed orientation.

### DESCRIPTION OF EMBODIMENTS

The description below deals with a connector unit as an embodiment of this disclosure with reference to drawings. This disclosure is, however, not limited to the embodiment below, and may be altered variously without departing from its scope.

### Basic Configuration

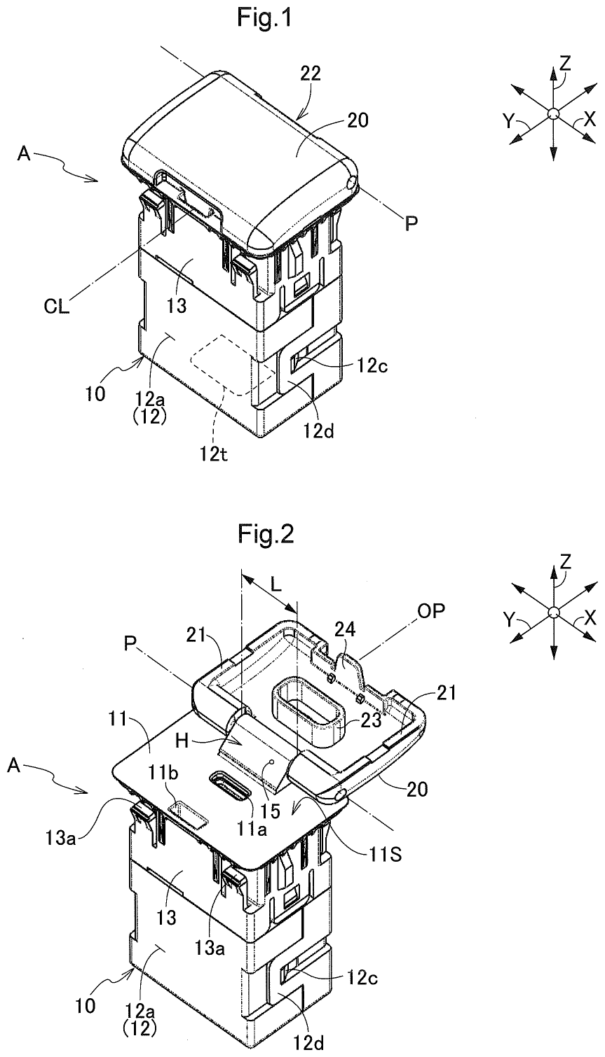

FIGS. 1 to 3 each illustrate a connector unit A including: a first connector 1; a second connector 2; a power supply circuit 3; a substrate 4 on which are mounted the first connector 1, the second connector 2, and the power supply circuit 3; a resin housing 10 containing the substrate 4 and including an end wall 11; a hinge H; and a resin lid 20 held by the end wall 11 with the hinge H in-between in such a manner as to be openable and closable.

The power supply circuit 3 does not necessarily include a power source such as a battery on the substrate 4, and may be configured to simply convert the voltage of externally supplied electric power. The connector unit A may omit the power supply circuit 3.

As illustrated in FIGS. 1, 2, 6, and 7, the lid 20 is coupled to the housing 10 in such a manner as to be rotatable about an open/close axis P into a closed orientation CL and an open orientation OP with use of the hinge H. In the closed orientation CL, the lid 20 covers an insertion hole 11a (described later) in the end wall 11 and has four edges 21 at least a portion of each of which faces the end wall 11 and is in contact with or closest to the end wall 11. The open orientation OP results from rotating the lid 20 about hinge shafts 26 (described later) of the hinge H from the closed orientation CL to the rotation limit.

The first connector 1 conforms to the USB® (Universal Serial Bus) standard. The connector unit A is designed to be disposed on, for example, the inner face of a door or a panel in the cabin of a vehicle such as an automobile. The connector unit A is usable as a charging terminal configured to supply electric power from the first connector 1 to a mobile terminal such as a smart phone or a tablet computer.

The connector unit A is usable in any orientation such as an orientation in which the first connector 1 faces laterally or obliquely upward. The description below assumes that the first connector 1 faces upward as illustrated in FIGS. 1 and 2 in dealing with the positional relationships between different components of the connector unit A.

Further, the description below deals with the above positional relationships with reference to (i) a lateral direction X along the width of the connector unit A (that is, parallel to the open/close axis P), (ii) a front-back direction Y along the depth of the connector unit A (that is, perpendicular to the open/close axis P and parallel to an outer wall face 11S of the end wall 11), and (iii) a vertical direction Z along the height of the connector unit A (that is, perpendicular to the open/close axis P and the outer wall face 11S) as illustrated in FIGS. 1 and 2. The description below also uses terms such as downward to refer to the side on which the housing 10 is present relative to the lid 20 in the vertical direction Z and terms such as upward to refer to the opposite side in the vertical direction Z.

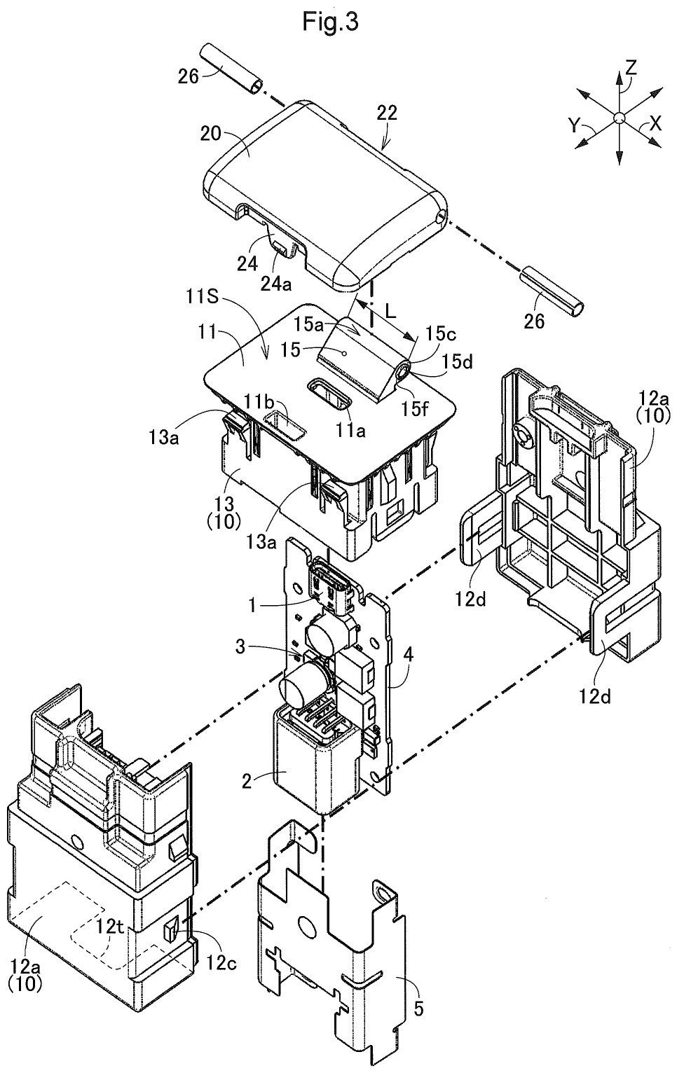

The connector unit A includes a metal shield 5. As illustrated in FIG. 3, the substrate 4 is contained in the housing 10 together with the shield 5. The substrate 4 has an upper end provided with the first connector 1 and a lower end provided with the second connector 2. The second connector 2 receives electric power from a power source of the vehicle. The power supply circuit 3 adjusts, for example, the voltage of the electric power and supplies the resulting electric power to the first connector 1.

### Housing

As illustrated in FIGS. 1 to 4, the housing 10 includes: a main housing section 12 as a combination of a pair of side walls 12a; and an auxiliary housing section 13 fitted around the upper end of the main housing section 12.

The side walls 12a each have a channel shape, that is, each have a cross section in an angular U shape in a plan view (that is, as viewed in the vertical direction Z). One of the side walls 12a includes a pair of lock protrusions 12c on respective outer walls to the left and right (that is, in the lateral direction X), whereas the other side wall 12a includes a pair of arms 12d lockable to the respective lock protrusions 12c. This configuration allows the side walls 12a to be coupled to each other.

With the above configuration, bringing the side walls 12a closer to each other causes the arms 12d to be locked to the respective lock protrusions 12c, so that the side walls 12a are coupled to each other and form a main housing section 12 in the form of a bottomed box. The main housing section 12 includes a bottom wall with an insertion opening 12t below the second connector 2. The side walls 12a are not necessarily coupled to each other with use of the lock protrusions 12c and the arms 12d, and may alternatively be coupled to each other in any other manner such as screwing the side walls 12a to each other.

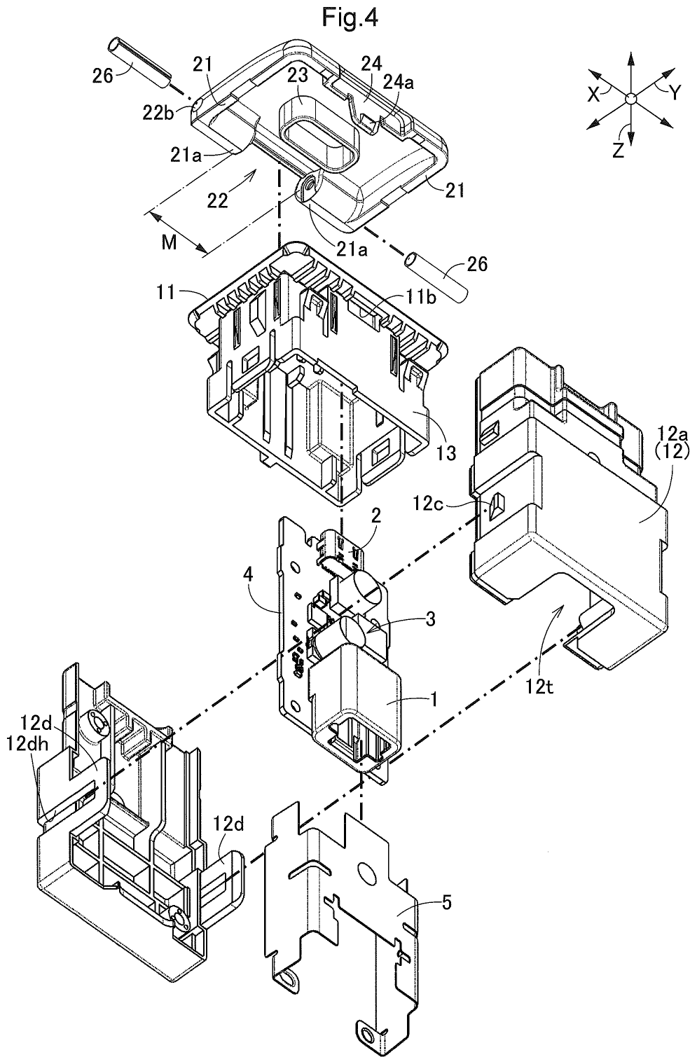

As illustrated in FIGS. 3 and 4, the auxiliary housing section 13 is in the form of a box open upward and downward and having a rectangular cross section. The auxiliary housing section 13 is coupled to the end wall 11 in such a manner that the upper opening in the auxiliary housing section 13 is blocked by the end wall 11. The end wall 11 is in the shape of a rectangle with a size larger than or equal to the outer shape of the auxiliary housing section 13 in a plan view. The end wall 11 covers the upper end of the auxiliary housing section 13. The end wall 11 has an insertion hole 11a through which a plug (not illustrated in the drawings) extends to be connected to the first connector 1. The auxiliary housing section 13 is fixedly fitted around an upper portion of the main housing section 12.

The auxiliary housing section 13 may include a pair of attachment sections 13a each configured to (i) elastically deform to allow the connector unit A to be moved to a predetermined position on an installation destination and (ii) return to its original shape in response to the connector unit A reaching the predetermined position to fix the connector unit A to the installation destination.

### Hinge

As illustrated in FIGS. 3 to 5, the lid 20 is overall in the form of a rectangular plate with four edges 21. With the lid 20 in the closed orientation CL, the edges 21 extend downward to be in contact with the end wall 11 so that the lid 20 has a central portion with an upwardly depressed lower face. One of the edges 21 includes a hinge depression 22 in the form of a partial cutout. The description below uses the term “depression dimension M” to refer to the dimension of the hinge depression 22 along the lateral direction X.

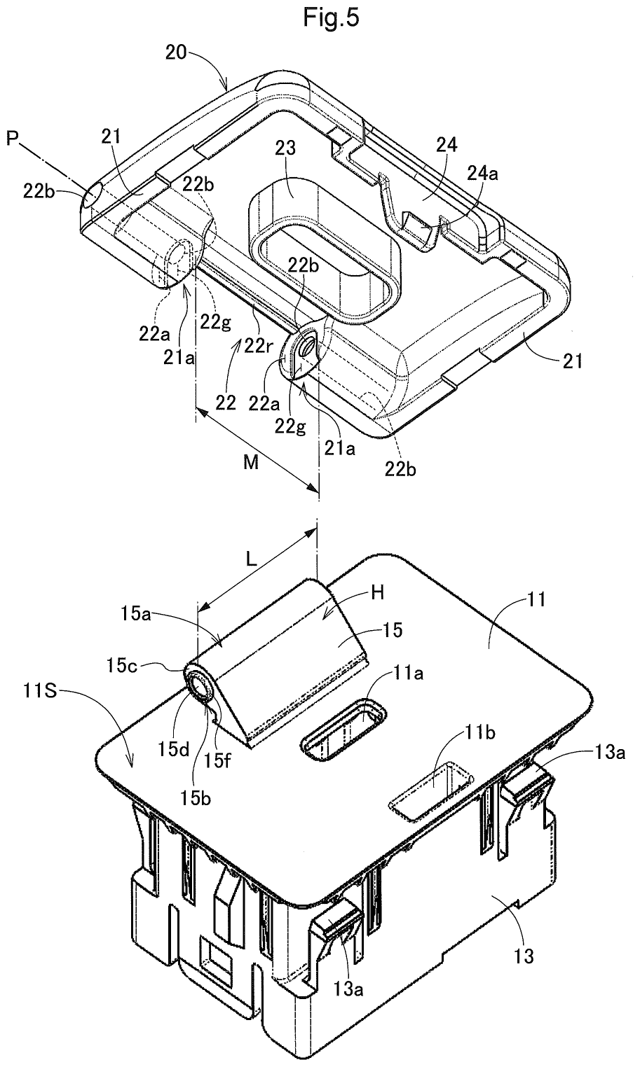

While the hinge H includes a hinge block 15 (see FIGS. 3 and 5) with two opposite block end faces 15c, the lid 20 includes a pair of bearings 21a at respective portions adjacent to the hinge depression 22 and facing the respective block end faces 15c.

As illustrated in FIGS. 3 to 5, the hinge H includes a hinge block 15 integral with the end wall 11, a pair of bearings 21a, and a pair of hinge shafts 26. The hinge H is a collection of components that allow the lid 20 to be supported by the end wall 11 in such a manner as to be rotatable about the open/close axis P to be opened and closed. The hinge block 15 is so sized as to be fitted in the hinge depression 22.

The hinge block 15 is on the outer wall face 11S of the end wall 11 and apart from the insertion hole 11a. The hinge block 15 has a predetermined dimension L in the lateral direction X. The depression dimension M of the hinge depression 22 is equal to or slightly larger (0.1 mm to several millimeters) than the predetermined dimension L.

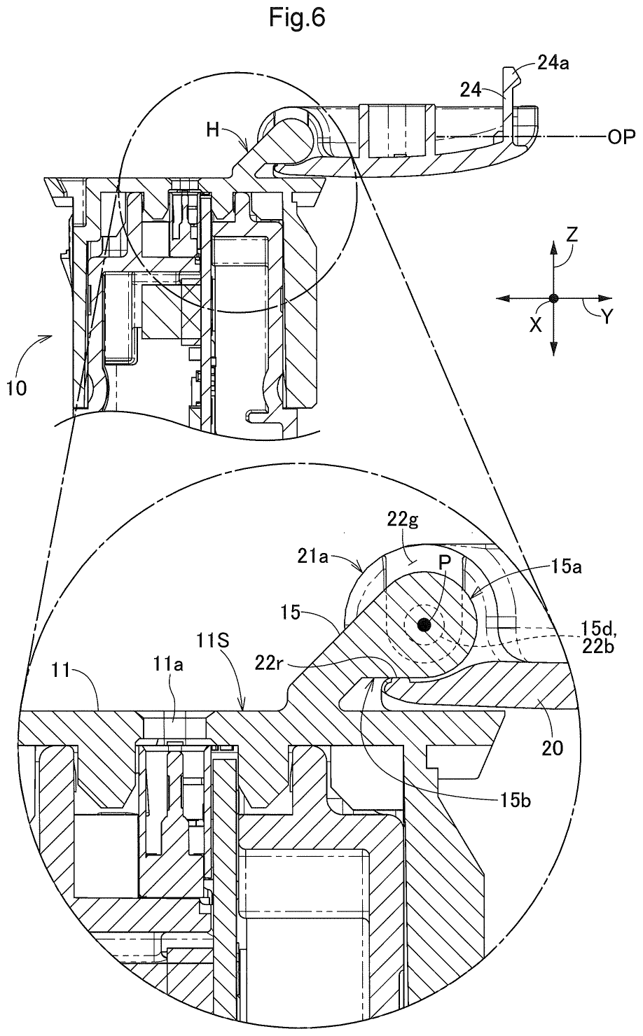

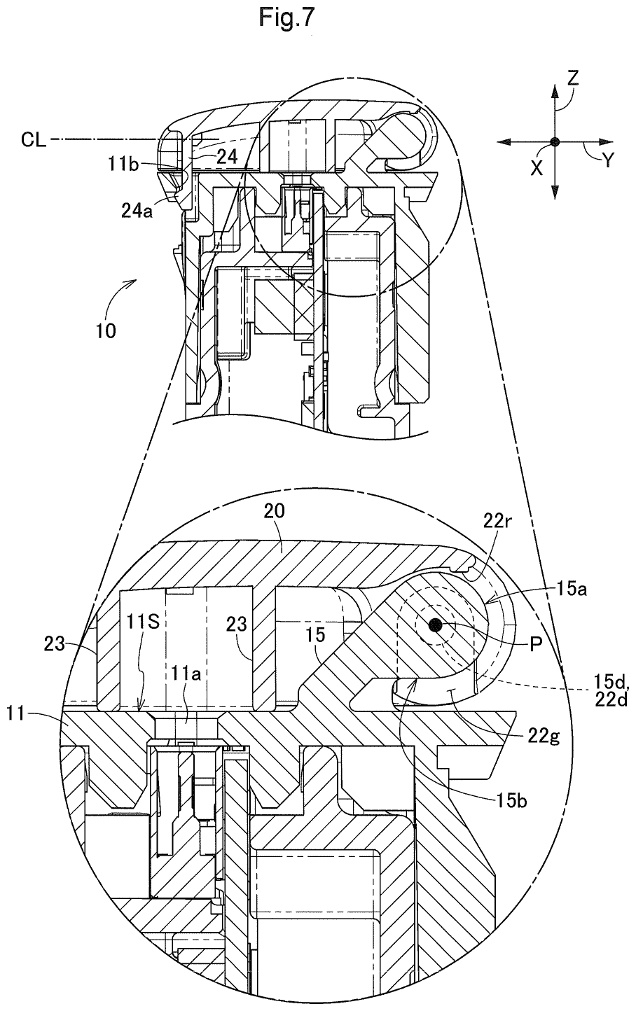

As illustrated in FIGS. 6 and 7, the hinge block 15 is so oriented obliquely in its entirety that a portion farther apart from the insertion hole 11a is farther apart from the outer wall face 11S of the end wall 11 as viewed along the open/close axis P (that is, as viewed along a first axial hole 15d described later). The hinge block 15 has a protrusion end with a circumferential surface 15a as a side surface of the cylinder with the open/close axis P at its center. The hinge block 15 has a contact surface 15b at a portion of the circumferential surface 15a which portion faces the outer wall face 11S. The contact surface 15b is in contact with a contact section 22r (described later) with the lid 20 in the open orientation OP.

As illustrated in FIGS. 3 and 5, the hinge block 15 has opposite block end faces 15c at respective ends in the lateral direction X which block end faces 15c are perpendicular to the open/close axis P. The hinge block 15 may have (i) a single first axial hole 15d in the form of a through hole extending from one block end face 15c to the other along the open/close axis P or (ii) two first axial holes 15d in the form of blind holes in the respective block end faces 15c which first axial holes 15d extend along the open/close axis P.

As illustrated in FIG. 5, the bearings 21a of the lid 20 face each other and have respective lid end faces 22a facing the hinge depression 22. The bearings 21a have respective second axial holes 22b each in the form of a through hole extending from the corresponding lid end face 22a through the lid 20 in the lateral direction X along the open/close axis P. The second axial holes 22b face each other across the hinge depression 22.

With the above configuration, fitting the hinge block 15 into the hinge depression 22 and inserting the hinge shafts 26 through the respective second axial holes 22b and the first axial holes 15d allows the lid 20 to rotate about the open/close axis P relative to the end wall 11. The hinge shafts 26 may each be in the form of (i) a cylinder-like element processed from a metal plate to have a C-shaped cross section, (ii) a bar extending in the lateral direction X, (iii) an element elastically deformable toward the open/close axis P to have a smaller diameter, or (iv) a bar made of an elastic material. For case (iii), any material and processing method are usable; for instance, a metal plate may be processed into a cylinder having a C-shaped cross section and elastically deformable to have a narrowed hollow and a smaller diameter in response to a radial load.

The hinge H may include two hinge shafts 26. The present embodiment is configured such that the bearings 21a have respective second axial holes 22b arranged in the lateral direction X and each containing a single hinge shaft 26 (see FIG. 4) and that the hinge block 15 has two first axial holes 15d arranged in the lateral direction X and separated from each other by a bottom wall.

### Rotation Limits of Lid

As described above, the lid 20 is switchable into a closed orientation CL illustrated in FIGS. 1 and 7 (that is, the rotation limit on the closing side) and an open orientation OP illustrated in FIGS. 2 and 6 (that is, the rotation limit on the opening side).

The lid 20 includes a sleeve 23 in the shape of an elongate ring in a plan view and with the lid 20 in the closed orientation CL, in contact with an area around the insertion hole 11a. With the lid 20 in the closed orientation CL and the sleeve 23 in contact with the outer wall face 11S of the end wall 11, the edges 21 may be in contact with or slightly apart from the outer wall face 11S. The lid 20 may omit the sleeve 23, in which case the edges 21 may at least partially be in contact with the end wall 11 with the lid 20 in the closed orientation CL.

As illustrated in FIGS. 4 and 7, the lid 20 includes a plate 24 on that one of the edges 21 which is opposite to the hinge depression 22 in a plan view. The plate 24 protrudes downward toward the end wall 11 with the lid 20 in the closed orientation CL, and includes a latch protrusion 24a at a leading end. The end wall 11 has a latch hole 11b in which the latch protrusion 24a latches in response to the lid 20 reaching the closed orientation CL illustrated in FIG. 7.

With the above structure, rotating the lid 20 into the closed orientation CL to engage the latch protrusion 24a with the edge of the latch hole 11b as illustrated in FIG. 7 results in the lid 20 reaching its rotation limit on the closing side and thereby being prevented from being moved toward the opening side. The connector unit A is configured to keep the lid 20 in the closed orientation CL as above to keep the protruding end of the sleeve 23 in close contact with that area of the outer wall face 11S of the end wall 11 which is around the insertion hole 11a. The connector unit A may have a so-called half-lock structure; that is, rotating the lid 20 from the closed orientation CL with use of a finger or the like may elastically move the plate 24 slightly toward the sleeve 23 to disengage the latch protrusion 24a from the latch hole 11b.

As illustrated in FIGS. 5 and 6, the lid 20 includes a contact section 22r configured to, in response to the lid 20 being rotated toward the open orientation OP, come into contact with a lower portion of the circumferential surface 15a of the hinge block 15 to define a limit of the rotation of the lid 20 on the opening side.

With the lid 20 in the open orientation OP (that is, the rotation limit on the opening side), the end wall 11 is parallel to the top wall of the lid 20. With the lid 20 in the open orientation OP, the contact section 22r is in contact with the contact surface 15b of the hinge block 15. The lid 20 in the open orientation OP is angled at approximately 180 degrees relative to the lid 20 the closed orientation CL.

The contact section 22r is integral with the lid 20 at an edge of the hinge depression 22, and protrudes toward the open/close axis P. The contact section 22r may alternatively be included in the hinge block 15. The contact section 22r has a dimension along the open/close axis P which dimension is equal to or slightly smaller than the depression dimension M. The contact section 22r is so positioned as to be covered by the lid 20 in a plan view with the lid 20 in the closed orientation CL. The contact section 22r is, in this state, invisible in a plan view.

### Assembly Assisting Structure of Lid

As illustrated in FIGS. 3 and 5, the hinge block 15 includes a pair of annular protruding engagement sections 15f protruding from respective central areas of the block end faces 15c outward along the open/close axis P (that is, in the lateral direction X). The protruding engagement sections 15f each have an axis coinciding with the open/close axis P. The first axial holes 15d each have an axis coinciding with the open/close axis P, and extends in the lateral direction X.

The protruding engagement sections 15f, in other words, each serve to keep the area around the corresponding first axial hole 15d apart from the corresponding block end face 15c.

As illustrated in FIG. 5, the lid 20 includes a pair of grooves 22g disposed in respective central areas of the lid end faces 22a of the bearings 21a which central areas have respective second axial holes 22b and configured to receive the respective protruding engagement sections 15f. The grooves 22g each extend from an edge of the corresponding lid end face 22a to an area around the corresponding second axial hole 22b. With the lid 20 in the closed orientation CL, the grooves 22g are each open downward in a direction radially outward of the corresponding second axial hole 22b (see FIG. 7). With the lid 20 in the closed orientation CL, the grooves 22g each have an upper inner surface in the shape of a semicircular arc coaxial with the corresponding second axial hole 22b and having an inner diameter substantially equal to the outer diameter of the corresponding protruding engagement section 15f.

The above configuration allows the lid 20 to be coupled to the hinge block 15 as follows: The protruding engagement sections 15f at the respective block end faces 15c of the hinge block 15 are inserted into the respective grooves 22g in the lid end faces 22a from the open side. In this state, the lid 20 and the housing 10 are moved relative to each other to bring each protruding engagement section 15f close to (or in contact with) the semicircular arc of the corresponding groove 22g and to thereby allow the first axial holes 15d to be coaxial with the second axial holes 22b.

After the relative movement, the hinge shafts 26 are inserted through the respective second axial holes 22b (which are each open in an outer wall face of the lid 20) into the respective first axial holes 15d. This assembles the hinge H, which allows the lid 20 to be rotatably coupled to the housing 10 (or the end wall 11). If the hinge block 15 has a single first axial hole 15d in the form of a through hole extending in the lateral direction X, the hinge H may include only one hinge shaft 26. In this case, the single hinge shaft 26 is inserted through one of the second axial holes 22b and the first axial hole 15d into the other second axial hole 22b to assemble the hinge H.

### Advantages of Embodiment

As described above, the connector unit A is configured as follows: Rotating the lid 20 from the closed orientation CL toward the open orientation OP brings the contact section 22r of the lid 20 into contact with the hinge block 15, causing the lid 20 to reach its opening limit, that is, the open orientation OP. In the open orientation OP, the lid 20 is as rotated by approximately 180 degrees from the closed orientation CL and is open widely, which allows a plug to be easily inserted into and pulled out of the first connector 1.

Repeatedly rotating the lid 20 between the closed orientation CL and the open orientation OP does not easily cause, for example, a contact scratch or a wear mark on a visible surface of the lid 20 or the auxiliary housing section 13, preventing the appearance from being impaired.

The lid 20 has grooves 22g each extending from the open/close axis P (about which the lid 20 is openable and closable) radially toward the end wall 11 with the lid 20 in the closed orientation CL. With the grooves 22g, orienting the lid 20 similarly to the closed orientation CL and moving the entire lid 20 toward the end wall 11 allows the first axial holes 15d to be coaxial with the second axial holes 22b, facilitating the attachment of the lid 20 to the housing 10.

Rotating the lid 20 into the closed orientation CL latches the latch protrusion 24a of the plate 24 into the latch hole 11b in the end wall 11 to keep the lid 20 in the closed orientation CL. With the lid 20 in the closed orientation CL, both the edges 21 and the sleeve 23 surround the insertion hole 11a in the end wall 11. With the protruding end of the sleeve 23 in contact with the end wall 11, the edges 21 and the sleeve 23 prevent dust or water from entering the insertion hole 11a.

The hinge His assembled as follows: First, the protruding engagement sections 15f of the hinge block 15 are inserted into the respective grooves 22g in the lid end faces 22a of the lid 20. Then, in this state, the lid 20 and the housing 10 are moved relative to each other to bring each first axial hole 15d close to the corresponding second axial hole 22b and to easily allow the first axial holes 15d to be coaxial with the second axial holes 22b. In this state, the hinge shafts 26 are inserted through the respective second axial holes 22b (which are each open in an outer wall face of the lid 20) into the respective first axial holes 15d.

The contact section 22r has a dimension along the open/close axis P which dimension is equal to or slightly smaller than the depression dimension M. This ensures the contact between the contact section 22r and the hinge block 15. This in turn prevents the contact section 22r and the hinge block 15 from being easily deformed or worn out as a result of repeatedly bringing the contact section 22r into contact with the hinge block 15, and allows the lid 20 to be kept at the predetermined position of its opening limit. With the lid 20 in the closed orientation CL, the contact section 22r protrudes toward the open/close axis P and thereby has a large thickness. This prevents the contact section 22r from being damaged (for example, cracked) due to a contact impact, and also prevents the contact section 22r from having a strength decreased due to short shot or a weld line during the molding process.

### Alternative Embodiments

This disclosure may be configured as below in addition to the embodiments described above. Any element described below that functions as described for the embodiments above is assigned with the same reference numeral as that for embodiments above.
(a) The connector unit A may include on the outer wall face 11S of the end wall 11 such an exposed component as a small switch or a lamp configured to indicate the operating state of the connector unit A. Rotating the lid 20 into the closed orientation CL allows the lid 20 to cover such a switch or a lamp.
(b) The embodiment described above is configured such that the hinge block 15 has block end faces 15c provided with respective protruding engagement sections 15f and that the lid 20 includes a pair of bearings 21a provided with respective grooves 22g. The embodiment may be altered conversely such that the hinge block 15 has block end faces 15c provided with respective grooves and that the lid 20 includes a pair of bearings 21a provided with respective protruding engagement sections.

The above configuration also allows the first axial holes 15d to be readily coaxial with the second axial holes 22b when the lid 20 is to be attached to the hinge block 15.
(c) The housing 10 does not necessarily include a main housing section 12 and an auxiliary housing section 13 as described for the above embodiment; the housing 10 may alternatively be an integral whole or include three or more housing sections. The housing 10 may further alternatively omit the end wall 11 described for the above embodiment.

The arrangements disclosed for the above embodiments (including the alternative embodiments; hereinafter the same) may each be combined with an arrangement disclosed for another embodiment, as long as such a combination does not cause a contradiction. Further, the embodiments disclosed in the present specification are mere examples. The present disclosure is not limited to those embodiments, and may be altered as appropriate, as long as such an alteration does not result in a failure to attain an object of the present disclosure.

1. A connector unit, comprising:
a connector;
a substrate on which the connector is mounted;
a housing containing the substrate and including an end wall with an insertion hole configured to receive a plug to be inserted in the connector;
a lid attached to the housing and switchable between a closed orientation, in which the lid blocks the insertion hole, and an open orientation, in which the lid exposes the insertion hole; and
a hinge connected to the housing and the lid and coupling the lid to the housing in such a manner that the lid is switchable between the closed orientation and the open orientation,
the hinge including:
a hinge block disposed on an outer wall face of the end wall, having a first axial hole parallel to the outer wall face, and having a contact surface facing the outer wall face;
at least one bearing disposed on the lid and having a second axial hole; and
a hinge shaft extending through the first axial hole and the second axial hole and coupling the lid to the housing,
the lid being rotatable about the hinge shaft relative to the housing to be switched from the closed orientation to the open orientation,
the lid including a contact section configured to, during the rotation, come into contact with the contact surface to define a limit of the rotation on an opening side.

2. The connector unit according to claim 1, wherein
the lid has a hinge depression at an edge in which hinge depression the hinge block is fitted,
the second axial hole is coaxial with the first axial hole with the hinge block fitted in the hinge depression, and
the contact section is at a portion of the lid at which portion the hinge depression is present.

3. The connector unit according to claim 2, wherein
the hinge depression has a dimension along a longitudinal direction of the hinge shaft, and
the contact section has a dimension along the longitudinal direction of the hinge shaft which dimension is equal to or slightly smaller than the dimension of the hinge depression.

4. The connector unit according to claim 1, wherein
the at least one bearing includes two bearings with the hinge block in-between along a length of the hinge shaft.

5. The connector unit according to claim 2, wherein
the at least one bearing includes two bearings with the hinge block in-between along a length of the hinge shaft.

6. The connector unit according to claim 3, wherein
the at least one bearing includes two bearings with the hinge block in-between along a length of the hinge shaft.

7. The connector unit according to claim 1, wherein
the hinge block has a block end face having a central area in which the first axial hole is present,
the at least one bearing has a lid end face facing the block end face and having a central area in which the second axial hole is present,
the hinge block includes a protruding engagement section protruding from the central area of the block end face, and
the at least one bearing includes in the central area of the lid end face) a groove shaped to receive the protruding engagement section.

8. The connector unit according to claim 2, wherein
the hinge block has a block end face having a central area in which the first axial hole is present,
the at least one bearing has a lid end face facing the block end face and having a central area in which the second axial hole is present,
the hinge block includes a protruding engagement section protruding from the central area of the block end face, and
the at least one bearing includes in the central area of the lid end face) a groove shaped to receive the protruding engagement section.

9. The connector unit according to claim 3, wherein
the hinge block has a block end face having a central area in which the first axial hole is present,
the at least one bearing has a lid end face facing the block end face and having a central area in which the second axial hole is present,
the hinge block includes a protruding engagement section protruding from the central area of the block end face, and
the at least one bearing includes in the central area of the lid end face) a groove shaped to receive the protruding engagement section.

10. The connector unit according to claim 4, wherein
the hinge block has a block end face having a central area in which the first axial hole is present,
the at least one bearing has a lid end face facing the block end face and having a central area in which the second axial hole is present,
the hinge block includes a protruding engagement section protruding from the central area of the block end face, and
the at least one bearing includes in the central area of the lid end face) a groove shaped to receive the protruding engagement section.

11. The connector unit according to claim 5, wherein
the hinge block has a block end face having a central area in which the first axial hole is present,
the at least one bearing has a lid end face facing the block end face and having a central area in which the second axial hole is present,
the hinge block includes a protruding engagement section protruding from the central area of the block end face, and
the at least one bearing includes in the central area of the lid end face) a groove shaped to receive the protruding engagement section.

12. The connector unit according to claim 6, wherein
the hinge block has a block end face having a central area in which the first axial hole is present,
the at least one bearing has a lid end face facing the block end face and having a central area in which the second axial hole is present,
the hinge block includes a protruding engagement section protruding from the central area of the block end face, and
the at least one bearing includes in the central area of the lid end face) a groove shaped to receive the protruding engagement section.

13. The connector unit according to claim 7, wherein
the lid is rotatable about an open and close axis to be opened and closed, and
with the lid in the closed orientation, the groove extends radially from the open and close axis toward the end wall.

14. The connector unit according to claim 8, wherein
the lid is rotatable about an open and close axis to be opened and closed, and
with the lid in the closed orientation, the groove extends radially from the open and close axis toward the end wall.

15. The connector unit according to claim 9, wherein
the lid is rotatable about an open and close axis to be opened and closed, and
with the lid in the closed orientation, the groove extends radially from the open and close axis toward the end wall.

16. The connector unit according to claim 10, wherein
the lid is rotatable about an open and close axis to be opened and closed, and
with the lid in the closed orientation, the groove extends radially from the open and close axis toward the end wall.

17. The connector unit according to claim 11, wherein
the lid is rotatable about an open and close axis to be opened and closed, and
with the lid in the closed orientation, the groove extends radially from the open and close axis toward the end wall.

18. The connector unit according to claim 12, wherein
the lid is rotatable about an open and close axis to be opened and closed, and
with the lid in the closed orientation, the groove extends radially from the open and close axis toward the end wall.
